(19) United States
(12) Patent Application Publication
(10) Pub. No.: US 2007/0258159 A1
(43) Pub. Date: Nov. 8, 2007

(54) System and method for photo/art frame eternal depth illusion

(76) Inventor: James Leonard Driessen, Lindon, UT (US)

Correspondence Address: James L. Driessen, 305 N. 1130 E., Lindon, UT, 84042, US

(21) Appl. No.: 11/799,947

(22) Filed: May 3, 2007

Related U.S. Application Data
(60) Provisional application No. 60/746,610, filed on May 5, 2006.

(51) Int. Cl. G02B 7/182

(52) U.S. Cl. 359/871

(57) ABSTRACT

Hand engraved etchings, computer generated sandblastings, transparencies, or any other photo or art work may be precisely and deliberately placed within the interior of a lighted “shadow box” fine art frame. Those photo and art works are then either directly or indirectly applied onto or used in conjunction with glass, acrylic, or other framing components, to create a plurality of lights, glass, half-silvered glass, and mirrors within the photo/art frame housing. The framing components secure the glass and mirrors in various diametrically situated positions as to cause an illusion of eternal reflection of not only the lighting elements, but also of the art work. The Photo/Art Frame Eternal Depth Illusion invention brings together the worlds of photo and art framing together with the infinity lighting concept. This system and method allows for the light and artwork to be reflected seemingly endlessly and to create a seemingly eternal depth illusion for a work of art or photo to be used in many different applications.

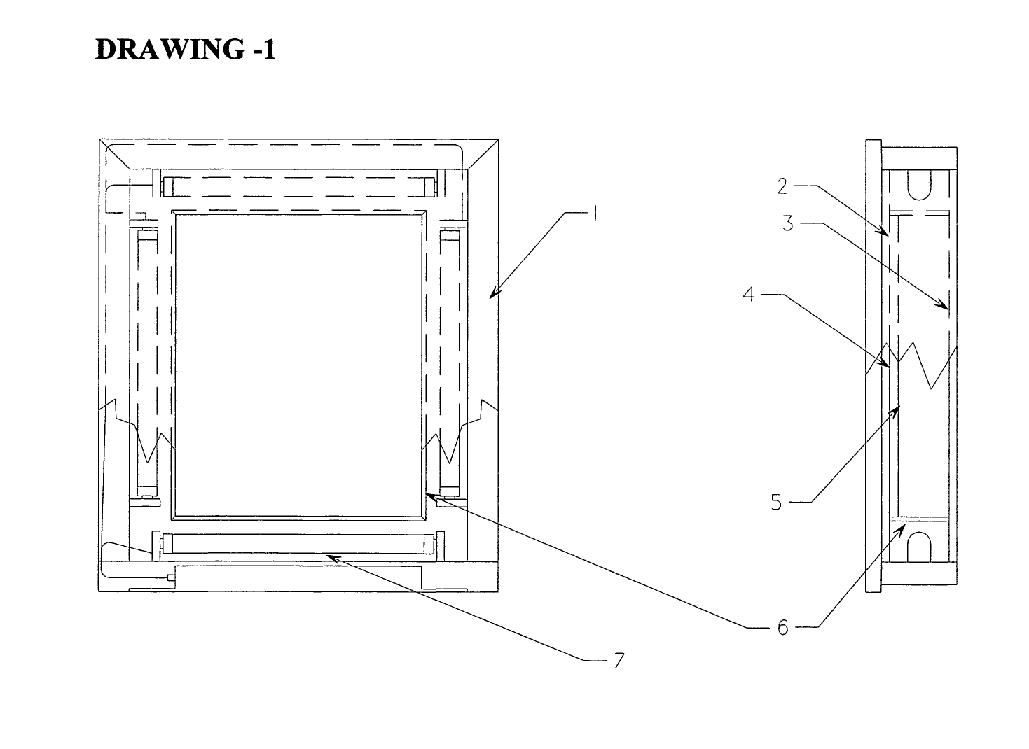

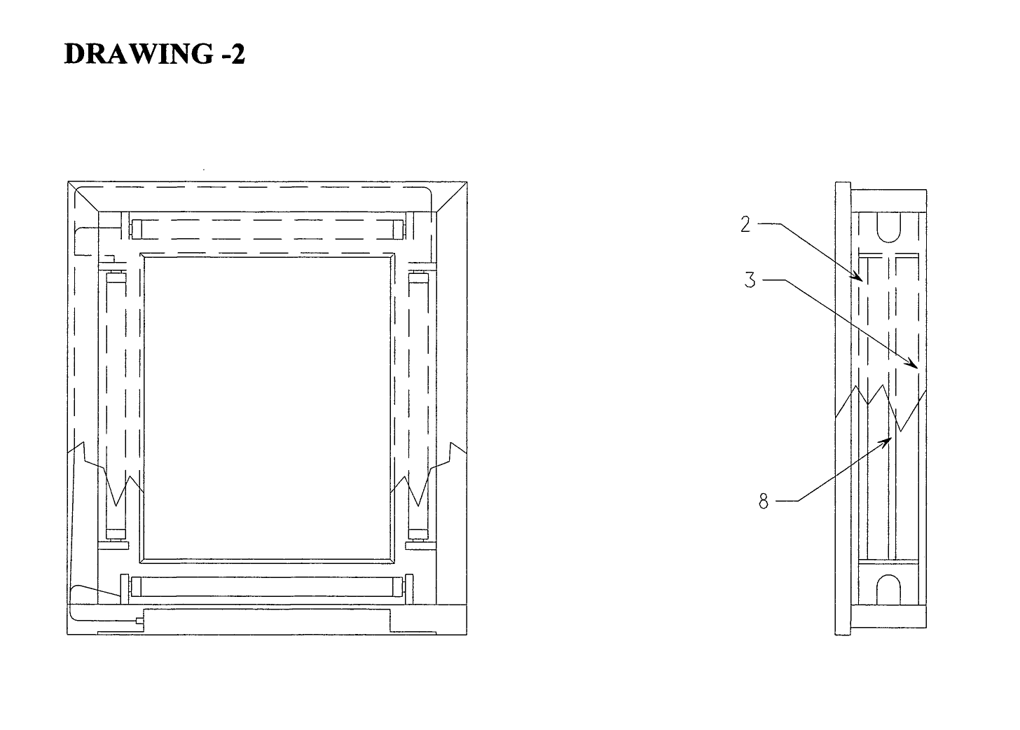

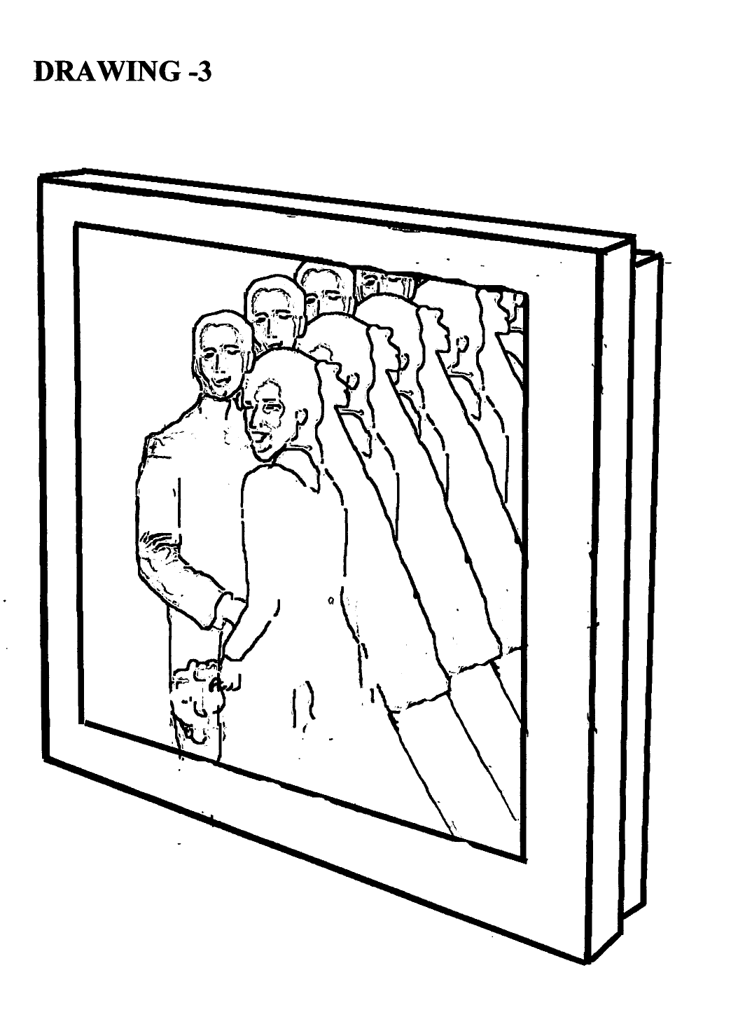

### RELATED APPLICATIONS

Inventor claims priority related to Provisional Application No. 60746610 filed on May 5, 2006_entitled System and Method for Eternal Depth Illusion for a photo/art Frame filed by same applicant with same named inventor.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC

Not Applicable

### BACKGROUND OF THE INVENTION

Framing of fine art and photography is a well developed and defined prior art going back literally hundreds of years.

Multiple mirror reflections caused by diametrically facing mirrors is an effect that may not be obvious, but has been discovered by many a curious individual holding one mirror up to another and noticing how the reflections seem to bounce back and forth with a seemingly endless tunnel. Two mirrors juxed-opposed in this manner will cause reflections of the same room, room contents, and room occupants with smaller and smaller reflections that appear to the naked eye to go on forever.

Wall hung and table versions of infinity reflecting mirrors used as frame lighting concepts have been readily available at retail and through mail order for at least several years. Those “infinity lights” used one “half-silvered” glass (also called a “one-way” mirror) on the front of a casing reflecting onto a second fully silvered mirror on the back side of the casing with lights placed in between causing an illusion that there was a tunnel of multiple rows of lights when in fact there was only one row of lights.

The present invention came about as something entirely different from just a novelty lighting concept, but was created to provide art lovers the opportunity to have their memories placed within an exquisite-quality frame. Art and photography enthusiasts can depict their art or photographic memory in an eternal setting, such as with family or with wedding album pictures. In Utah, the State where the invention took place and where the predominant faith of the community has historically focused on the eternal nature of marriage and family, an art/photography framing system that depicted the eternal nature of all things in an entirely new and cost-effective way, was a long-felt need in the community.

An effect of seeing one's reflection many times over as it gets smaller and smaller down the reflective tunnel created in mirrors, is an observation that has been made by people probably for as long as there have been mirrors, but to observe it, one had to actually be in between the mirrors.

Another eternal reflecting effect has been found using video cameras pointed at mirrors or at video monitors. If you point a video camera at a mirror or video monitor, the observer (who is the person holding the camera or the audience later viewing the film) can observe endless reflections of the without being inside (in between the mirrors), but depending on the angle, the camera itself was also captured in the mirror. It is practically impossible to keep the camera out of the picture, especially, if shot straight on; the artist has to somehow hide or disguise the camera to get the desired affect.

The System and Method for Photo/Art Frame Eternal Depth Illusion solves the problem of eternal reflection for the art work by allowing control over what reflections are carrying into the picture.

### BRIEF SUMMARY OF THE INVENTION

In the present invention, two or more mirrors are lined up within a frame so that the reflective sides of the glass are facing each other. A photograph, painting, sketch, or other artwork can then be placed on or between the mirrors along with illumination (lighting source) to create an endless reflection of the art and light in much the same way one would find if they held a mirror up behind them while facing another mirror with adequate lighting in the room. One need only stand in a room somewhere with diametrically place mirrors on the walls to see how the room, the lights, and every object or occupant in the room seems to be reflected many times over a seemingly endless tunnel.

When the mirrors are in this position we say that they are diametrically positioned meaning that the reflective portions of the mirrors are at least in some respect facing each other. Diametrical should not be taken to mean that the mirrors must be exactly parallel or facing each other exactly because we know that no two planes are exactly parallel. But, we also do not mean that the two mirrors have to be precisely diametrical because mirrors can be concave, convex, or only approximately planar. One or more concave or convex mirrors can give projected artwork many different effects depending of the focal point of the concave or convex mirrors.

The mirrors in this invention can be directly facing each other or they can be slightly angled for various other effects, like creating the illusion of a curving, dipping, or diving reflective tunnel.

In the present invention, there does not have to be only two mirrors; the mirrors need not be square or rectangle; and there may be multiple mirrors from multiple directions. In a typical rectangular shadow-box frame, there can be mirrors on every side of the box making six (6) sides to work with and with effects that can be modified or enhanced depending on the depth of the shadowbox and how much surface area inside the frame can be covered with a mirror. Since an art/photo shadow box frame also need not be rectangular, any number of sides to the shadow box can be used as a mirror reflecting surface.

The last element of the present invention is a way for an outside observer to be able to view the reflections inside the reflecting box without putting themselves into the reflecting picture. In one embodiment of this invention, a pin camera can be placed into the shadow box and the reflecting art or photo can be captured on film or video monitor.

The reader of this patent may note that although we often call certain materials “transparent,” nothing is either totally transparent or totally opaque; there are just degrees of light that are either passed or blocked. Some materials allow passage of some gradient of light while others are measured by their ability to block light. Once a critical thickness of an opaque material is reached, we can say that all measurable passage of light has been blocked.

Likewise in the art of creating “half-silvered” or “half-mirrored” glass, acrylic, or other material, the “half” term does not denote some equally divided halves as a unit of measure, but is merely used here subjectively meaning a partially reflective property. The “half” is used arbitrarily in this sense to denote a partial reflection and a partial passing of light through the material, not necessarily “one-half” the light or “one-half” reflection In the present invention, different effects can be created using different materials with different reflective indexes for the “half-silvered” material placed on the front of the shadow-box frame.

### BRIEF DESCRIPTION OF THE SEVERAL VIEWS OF THE DRAWING

Drawing-1 shows the preferred embodiment of the invention which is the white light tunnel for photo and art frame.

Drawing-2 shows an embodiment where a third transparent material like glass or acrylic is placed between the two mirrors to allow another surface for adding depth or effect.

Drawing-3 depicts one embodiment of a System and Method for Photo/Art Frame Eternal Depth illusion.

### DETAILED DESCRIPTION OF THE INVENTION

In the preferred embodiment of this invention, the elements of the System and Method for Photo/Art Frame Eternal Depth illusion are kept most simple. It is important for the reader of this patent application to know, however, that simplicity is not a bar to patentability. Thus, depicting the preferred embodiment of the present invention using the most simple forms, terms, and illustrations will best allow the reader to quickly grasp the novelty and usefulness of this invention, but this simplicity is not to be taken to mean that the inventor in any way limits the embodiments of this invention to only the most simple: many complex embodiments which can be derived from the lessons taught in this application may be employed.

In practice, the System and Method for Photo/Art Frame Eternal Depth illusion must create the eternal depth illusion without bringing exterior elements into the art frame, meaning we want to be able to both view the photo or art work in the frame with all of its reflections without necessarily bringing in the room or the observer into the picture. It can certainly be imagined that in one embodiment or another, it may actually be desirable to allow the observer to put themselves into the endless reflection, but an object of the present invention is to be able to control what is and what is not brought into the reflecting tunnel.

Drawing-1 shows how two mirrors can be placed into a typical “shadow-box” art/photo frame. In this preferred embodiment, the fully silvered mirror is place on the back of the frame (3) with the reflective side of the mirror facing into the shadow box. The half-slivered mirror (2) is placed on the front of the shadow box just behind the decorative moulding or millwork (1).

A “matting” (4) which is well know in the prior art of framing, is applied between the moulding (1) and the half-silvered mirror (2), which sets the dimensions for the actual opening for observers of the frame to see into the reflecting tunnel. The moulding (1) and the matting (4) are certainly not required for the invention to function, but help to hide any of the mechanical parts from being seen by the observer.

The material used for the half-silvered mirror (2) and the fraction of particles used to create the half-mirror effect (often called a one-way mirror) is an important variable that allows in the preferred embodiment for the maker of the frame to create different effects.

Half silvered glass is a well-known technique in the art of windows. Just about everyone has seen a television show or movie in which a criminal suspect is questioned while detectives watch from behind a “one-way” mirror. The piece of glass manages to reflect light from one side while remaining clear on the other. The secret is that it doesn't really reflect all the light.

So why doesn't the “criminal suspect” see the detectives in the next room? The answer lies in the lighting of the two rooms. The room in which the glass looks like a mirror is kept very brightly lit, so that there is plenty of light to reflect back from the mirror's surface. The other room, in which the glass looks like a window, is kept dark, so there is very little light to transmit through the glass. On the criminal's side, the criminal sees his own reflection. On the detectives' side, the large amount of light coming from the criminal's side is what they see. In many ways, it's the same as if people were whispering in one room while a loud stereo played in the other. The sound of the whisper might carry into the room with the stereo, but it would be drowned out by the intensity of the music.

A one-way mirror has a reflective coating applied in a very thin, sparse layer—so thin that it's called a half-silvered surface. The name half-silvered comes from the fact that the reflective molecules coat the glass so sparsely that only a portion of the molecules needed to make the glass an opaque mirror are applied. At the molecular level, there are reflective molecules speckled all over the glass in an even film but the glass maker can control what fractional portion of the glass is covered, the term “half-silvered” is used by convention.

A truly half-silvered surface will reflect about half of the light that strikes its surface, while letting the other half go straight through.

In the present invention, if the reflective side (5) has a low refractive index, more light passes through the half-silvered mirror (2) and the observer can see more details of the picture/art inside. When lower reflective capability is employed, however, it may cause an effect where the depth of the reflective tunnel diminishes quickly and the reflective tunnel illusion becomes dark too soon. That is because each time the reflection takes place (at the speed of light which is not observable by the human eye) the subsequent reflection becomes darker by small degree depending on the reflective index of the front mirror and how much light is bounced back into the frame and how much escapes to the viewer. In the preferred embodiments, higher reflective index, meaning more light reflected back into the box is desirable because even limited amounts of light escaping to the viewer are adequate for the viewer to see into the box with an adequately lit interior of the shadow-box frame.

With the typical “one-way” mirror in the example of the police interrogation room, if the lights in the room with the mirror are suddenly turned out, or the lights in the observation room suddenly turned on, then the one-way mirror becomes a window, with people in each room able to see those in the other. You can see this effect in any mirrored office building at night—if the light is on in an office, you can see into the office just fine.

In the present invention however, since the lights are confined to limited space inside the shadow-box and are so bright and close to the mirrors that even relatively bright lights in the room do not approach the brightness from within side the box, thus a virtually “one-way” situation is actually created.

Also in the preferred embodiment a white diffuser (6) is placed between the lighting electronics (7), so that to the viewer all that is seen is a seemingly endless white tunnel with the desired photo/art work reflected down the tunnel for an illusion of eternity.

Various effects can be obtain by placing the photo/art work at different positions in or on the shadow box. In the preferred embodiment, a digital picture is taken of the desired subject matter for the frame, such as a wedding picture. That digital photo can then be manipulated and edited in a computer photo editing program and then uploaded to a computerized laser etching device which is also well known in the prior art.

Again referring only to this preferred embodiment with a wedding picture for example, the photographer may also take a picture of the church or temple where the couple was married. On the front surface (4) of the front mirror (2) a line art photo conversion of the church or temple can be made and laser etched onto the front surface of the front mirror as a background. Then the picture of the couple with all the background cropped can also be laser etched onto the front surface (4) of the front mirror (2). At this point if the front mirror were place on the shadowbox and the electronic lighting system (7) were turned on, the picture would appear as the couple standing in front of the church or temple with an empty endless white tunnel behind them.

For the desired effect in this embodiment, however, we do one more laser etching treatment to the back side (5) of the front mirror (2) which is accomplished by computer generating the mirror image of the married couple with the background cropped out. That reverse image is then laser etch onto the back side (5) of the front mirror (2).

When the front mirror (2) with the above laser etched treatments is then place onto the front of the shadow-box and the lighting system (7) is turned on, the picture that is seen is the couple standing in front of their church or temple and then behind them an endless reflection of just themselves reflecting down the white tunnel.

Different effects of course can be obtained by etching or not etching photographic or art subject matter, such as the church, trees, mountains, or really whatever combination of models and background may be desired and which ones are to be reflected down the tunnel and which are not. Art/photography etched on the front side (4) of the front mirror (2) will not be reflected, but things on the back side (5) of the front mirror (2) will be reflected.

Drawing-2 shows how a third or multiple transparent layer (8) can be placed between the front mirror (2) and back mirror (3). This layer or a plurality of transparent layers may be added to allow for more effects. For example, such as adding background, colored filter effects, or any imaginable effect that can be placed on in or around the multiple layers. In one embodiment a time lapse is created where a wedding couple takes another photograph years later while posing in the same or similar position as their original wedding photo. The original can be computer edited to a line drawing and then etched on the front side of the front mirror (2). The “aged” photo is also computer edited to a line drawing and then etched onto the back side of the front mirror (2). A laser printed color transparency is prepared of the original wedding photograph of the couple and placed in between the front mirror (2) and back mirror (3) as the third or multiple transparent layer (8). This will cause an effect that depending on the angle the observer looks they will either see an old or a young version of the couple reflected in the tunnel.

1. A method for creating an illusion of eternity in an art frame comprising:
placing one or more silvered mirrors diametrically positioned in relation to one or more half-silvered mirrors;
introducing light through lighting components placed between or adjacent to said mirrors;
etching, inscribing, or otherwise placing one or more photos or artworks on or between said mirrors; and
securing said mirrors and said lighting components to a framing unit.

2. The method according to claim 1, wherein said placing one or more silvered mirrors comprises placing one or more glass mirrors.

3. The method according to claim 1, wherein said placing one or more silvered mirrors comprises placing one or more acrylic mirrors.

4. The method according to claim 1, wherein said one or more half silvered mirrors comprises one or more glass or acrylic mirrors.

5. The method according to claim 1, wherein said one or more half silvered mirrors comprises one or more mirror made of any reflective material.

6. A photo or art frame comprising:
means for securing two or more mirrors to a plurality of framing components;
means for positioning said mirrors in diametrically opposed position;
means for securing one or more lighting components to said plurality of framing components where said lighting components illuminate an area between said mirrors; and
means for securing photographic or art work in said area between said mirrors.

7. The photo or art frame in claim 5 wherein said means for securing two or more mirrors further comprises means for securing two or more mirrors comprised of any reflective material.

8. A photo or art frame comprising:
a plurality of framing components;
at least one mirror;
at least one half-silvered mirror;
a plurality of lighting components; and
a plurality of photo or art images, wherein said photo or art images placed between said mirror and said half-silvered mirror are illuminated by said plurality of lighting components.
